(19) United States
(12) Patent Application Publication
(10) Pub. No.: US 2005/0080903 A1
(43) Pub. Date: Apr. 14, 2005

(54) Method, system, and program for maintaining a link between two network entities

(76) Inventor: Moshe Valenci, Givat-Zeev (IL)

Correspondence Address: KONRAD RAYNES VICTOR & MANN LLP, Suite 210, 315 S. Beverly Drive, Beverly Hills, CA, 90212, US

(21) Appl. No.: 10/675,085

(22) Filed: Sep. 30, 2003

(51) Int. Cl. G06F 15/16

(52) U.S. Cl. 709/227; 709/222

(57) ABSTRACT

Provided are a method, system, and program for maintaining a link between a first network entity and a second network entity. The first network entity includes a network adapter and a driver. With the network adapter, it is determined whether the driver was loaded before a link-shutdown timer expired. With the network adapter, processing continues without dropping the link in response to the driver being loaded before the link-shutdown timer expired. With the network adapter, the link is dropped in response to the driver not being loaded before the link-shutdown timer expired.

### BACKGROUND OF THE INVENTION

1. Field of the Invention

The present invention relates to a method, system, and program for maintaining a link between two network entities.

2. Description of the Related Art

In a Local Area Network (LAN), switches reside between segments of the LAN. Each switch receives data packets, determines the destination of the data packets, and forwards the data packets on to their destinations. For example, on an Ethernet local area network (LAN), a switch obtains a physical device address (i.e., Media Access Control or MAC address) from a data packet to identify the destination of the data packet. The switch may route the data packet to another switch that is on the path to the destination of the data packet. The term “Ethernet” is a reference to a standard for transmission of data packets maintained by the Institute of Electrical and Electronics Engineers (IEEE).

In some systems, a switch executes a spanning tree algorithm, which is activated as a default configuration of the switch. A spanning tree algorithm is used to implement a spanning tree protocol for discovering a network structure in order to efficiently route data packets and detect redundant paths to a destination address. In particular, in an Ethernet LAN, computers use a shared path. In implementing a spanning tree algorithm, the switch sends a message over the network. When responses to the message are received, each response includes an identification of the sender of that response. A spanning tree algorithm uses the sender data to obtain an understanding of the network structure (“network topology”).

A spanning tree algorithm is especially useful in preventing network storms by eliminating redundant network paths (i.e., paths that result in network path loops). Also, a spanning tree algorithm is used to select an efficient path for a data packet when multiple paths are possible. One spanning tree protocol and algorithm were developed by a committee of the IEEE.

As part of a spanning tree algorithm implementation, when a switch has a link transition occurring in one of its ports, the switch attempts to send spanning tree packets to explore the network structure. The switch also has a learning period during which the switch disables network activity through the explored port to prevent unicast, broadcast, and/or multicast storms caused by network path loops.

Additionally, a spanning tree algorithm has a complicated internal state machine, with different levels of activities to block traffic through the explored port. That is, network packets may flow in none or one direction, until the state stabilizes.

When a network entity, such as an Ethernet adaptor, has to be reconfigured, it may cause a link transition due to driver reload (i.e., the driver is unloaded and reloaded with new settings). Examples of reconfiguration phases include: reconfiguring “adapter teaming” (e.g., fault tolerance), which may cause a driver to be reloaded with different properties, such as a different MAC address, a different Virtual LAN (VLAN), etc.; changing adapter properties through an operating system network control application, which may result in reloading of a driver; and, automated certification testing, which tends to cause the adapter to be reloaded with different capabilities.

When a driver is unloaded (e.g., prior to being reloaded), there is no prior knowledge of whether the driver is going to be reloaded, so the link between the switch and the network adaptor is brought down in order to improve power consumption (assuming no wake up pattern is configured). When a driver reload occurs, the link has to be brought up again. In particular, once the link toggles, a spanning tree algorithm, on the switch, disables the port for a period of time (e.g., 30 seconds, which is a worst case default configuration). Disabling the port causes network unavailability for any link partner. Note that when a packet with a specific pattern is received the by network entity, receipt of the packet will often cause a power up event (e.g., turns on the machine). The wake up pattern may be received only if the link stays up.

When a switch gets a packet and does not know the destination port of the packet, the switch floods all ports with that packet (until the switch learns the right destination port). If there is a loop in the network, the switch might get this packet back again and may cause a network storm by sending this packet over and over again to all ports. One of the reasons that a spanning tree algorithm blocks traffic for a port for which a link was toggled is that this link may be creating a loop in the network (if connected to another switch), and this is inherently wrong when a network endpoint (e.g., a computer) is connected.

Therefore, there is a continued need in the art to improve maintenance of a link.

### BRIEF DESCRIPTION OF THE DRAWINGS

Referring now to the drawings in which like reference numbers represent corresponding parts throughout:

FIG. 1 illustrates a computing environment in which certain embodiments of the invention are implemented;

FIG. 2 illustrates a network in accordance with certain embodiments of the invention;

FIG. 3 illustrates operations for a shutdown sequence in a driver in accordance with certain embodiments of the invention;

FIG. 4 illustrates operations for a load sequence in a driver (e.g., a device driver 120) in accordance with certain embodiments of the invention;

FIG. 5 illustrates operations for processing a link-shutdown timer in a physical communications layer in accordance with certain embodiments of the invention; and

FIG. 6 illustrates one embodiment of a computer architecture 600 of the network components, such as the computer shown in FIG. 1.

### DETAILED DESCRIPTION OF THE EMBODIMENTS

In the following description, reference is made to the accompanying drawings which form a part hereof and which illustrate several embodiments of the present invention. It is understood that other embodiments may be utilized and structural and operational changes may be made without departing from the scope of embodiments of the present invention.

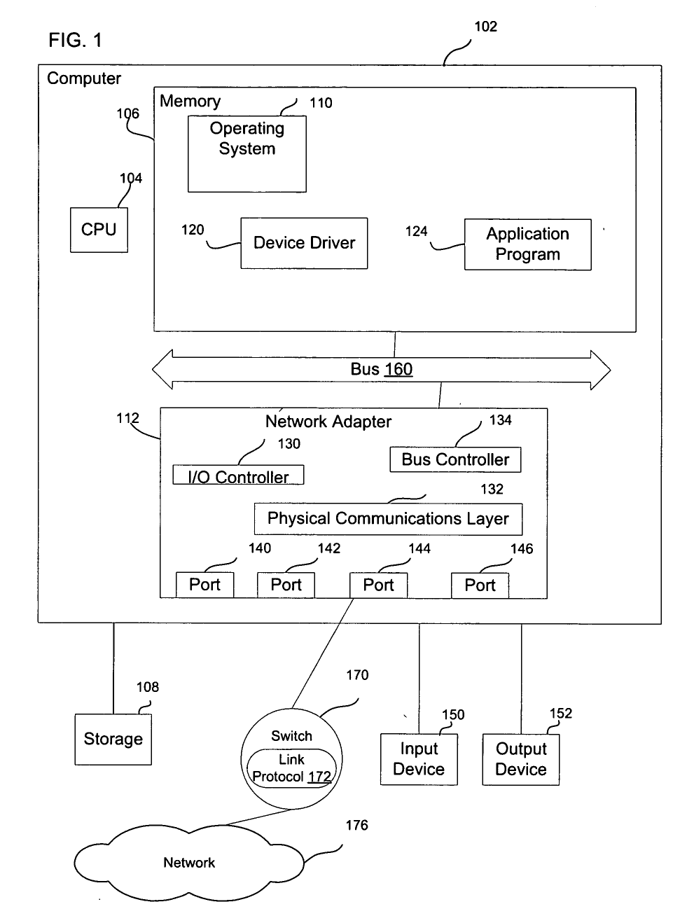

FIG. 1 illustrates a computing environment in which embodiments of the invention may be implemented. A computer 102 includes one or more central processing units (CPUs) 104, a volatile memory 106, non-volatile storage 108 (e.g., magnetic disk drives, optical disk drives, a tape drive, etc.), an operating system 110, and one or more network adapters 112. The computer 102 may comprise any computing device known in the art, such as a mainframe, server, personal computer, workstation, laptop, handheld computer, telephony device, network appliance, virtualization device, storage controller, etc. Although only one network adapter is shown, the computer 102 may include more than one network adapters. An application program 124 further executes in memory 106 and is capable of transmitting and receiving packets from a remote computer over the network 176 via switch 170. Switch 170 may include a Network Interface Controller (NIC) and may execute a link protocol (e.g., a spanning tree protocol or a fast spanning tree protocol). The term “link protocol” refers to any technique that tries to learn a network topology and/or any protocol that detects or eliminates redundant network paths. The computer 102 may comprise any computing device known in the art, such as a mainframe, server, personal computer, workstation, laptop, handheld computer, telephony device, network appliance, virtualization device, storage controller, etc. Any CPU 104 and operating system 110 known in the art may be used. Programs and data in memory 106 may be swapped into storage 108 as part of memory management operations.

The network adapter 112 includes various components implemented in the hardware of the adaptor. The network adapter 112 is capable of transmitting and receiving packets of data over network 176, which may comprise a Local Area Network (LAN), the Internet, a Wide Area Network (WAN), Storage Area Network (SAN), WiFi, Wireless LAN, Wireless WAN, etc.

A device driver 120 executes in memory 106 and includes network adapter 112 specific commands to communicate with the network adapter 112 and interface between the operating system 110 and the network adapter 112. The network adapter 112 or device driver 120 would implement logic to process the packets, such as a transport protocol layer to process the content of messages included in the packets that are wrapped in a transport layer, such as Transmission Control Protocol (TCP) and/or Internet Protocol (IP), the Internet Small Computer System Interface (iSCSI), Fibre Channel, SCSI, parallel SCSI transport, or any other transport layer protocol known in the art. The transport protocol layer would unpack the payload from the received TCP/IP packet and transfer the data to the device driver 120 to return to the application program 124. Further, an application program 124 transmitting data would transmit the data to the device driver 120, which would then send the data to the transport protocol layer to package in a TCP/IP packet before transmitting over the network 176.

A bus controller 134 enables the network adapter 112 to communicate on a computer bus 160, which may comprise any bus interface known in the art, such as a Peripheral Component Interconnect (PCI) bus, Small Computer System Interface (SCSI), Serial ATA, etc. The network adapter 112 includes a network protocol for implementing the physical communication layer 132 to send and receive network packets to and from remote devices over a network 176. In certain embodiments, the network adapter 112 may implement the Ethernet protocol, token ring protocol, Fibre Channel protocol, Infiniband, Serial Advanced Technology Attachment (SATA), parallel SCSI, serial attached SCSI cable, etc., or any other network communication protocol known in the art.

The network adapter 112 includes an I/O controller 130. In certain embodiments, the I/O controller 130 may comprise an Ethernet Media Access Controller (MAC) or Network Interface Controller (NIC), and it is understood that other types of network controllers, I/O controllers such as Small Computer System Interface (SCSI controllers), or cards may be used.

The storage 108 may comprise an internal storage device or an attached or network accessible storage. Programs in the storage 108 are loaded into the memory 106 and executed by the CPU 104. An input device 150 is used to provide user input to the CPU 104, and may include a keyboard, mouse, pen-stylus, microphone, touch sensitive display screen, or any other activation or input mechanism known in the art. An output device 152 is capable of rendering information transferred from the CPU 104, or other component, such as a display monitor, printer, storage, etc.

In certain embodiments, in addition to the device driver 120, the computer 102 may include other drivers, such as a transport protocol driver (not shown) that would perform the functions of the transport protocol layer.

The network adapter 112 may include additional hardware logic to perform additional operations to process received packets from the computer 102 or the network 176. Further, the network adapter 112 may implement a transport layer offload engine (TOE) to implement the transport protocol layer in the network adapter as opposed to the computer device driver 120 to further reduce computer 102 processing burdens. Alternatively, the transport layer may be implemented in the device driver 120.

Various structures and/or buffers (not shown) may reside in memory 106 or may be located in a storage unit separate from the memory 106 in certain embodiments.

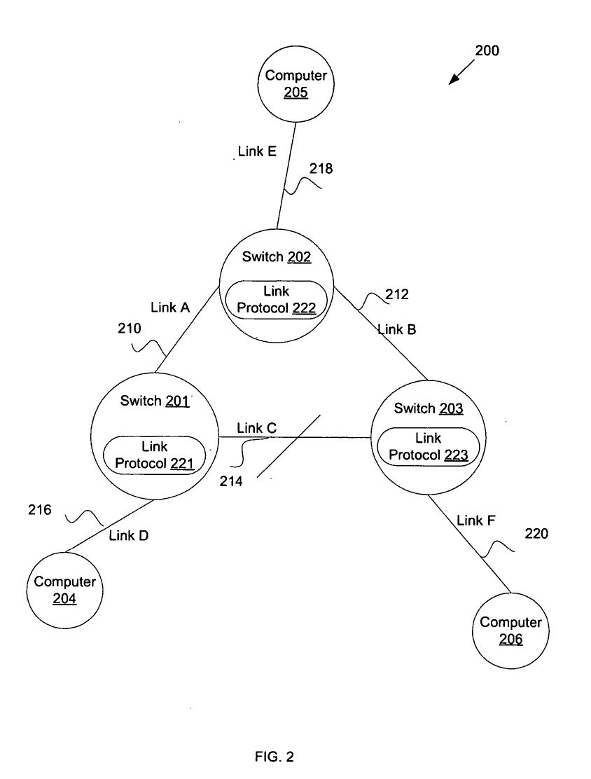

FIG. 2 illustrates a network 200 in accordance with certain embodiments of the invention. Each circle represents a network entity (e.g., a switch or a computer) in the network 200. For ease of reference, the connections between a switch and another switch or computer will be referred to as “links.” A path from one network entity to another network entity is described using the links.

Each switch 201, 202, and 203 includes a link protocol 221, 222, and 223, respectively. Each link protocol 221, 222, and 223 (e.g. a spanning tree algorithm) attempts to detect loops in the network 200. Since the network topology may change, the link protocols 221, 222, and 223 may periodically or continuously attempt to detect loops. If a loop is detected, then the switches 201, 202, and 203 generate paths for data to avoid the loops.

In FIG. 2, switch 201 is connected to switch 202 by link A 210. Switch 202 is connected to switch 203 by link B 212. Switch 203 is connected to switch 201 by link C 214, but, in the illustration the connection via link C is down or discarded (e.g., kept as an inactive backup link by the link protocol). That is, in certain embodiments, link C may be discarded by the link protocol to avoid path loops. Also, computer 204 is connected to switch 201 by link D 216. Computer 205 is connected to switch 202 by link E 218. Computer 206 is connected to switch 203 by link F 220.

A network entity may be unable to determine whether a neighboring network entity is a computer or a switch, since these appear the same. Therefore, switch 201, switch 202, switch 203, and computer 206, in this example, use link protocols 201, 202, and 203, respectively, to proactively attempt to detect a loop in the network 200 by sending one or more probe packets (e.g., a spanning tree packet) over the network 200. If any of switch 201, switch 202, switch 203, and/or computer 206 receives the probe packets back from a different port than the one from which the probe packets were sent from, then a loop exists in the network 200. For example, if switch 201 sends probe packets from a first port and receives them back from another port, then switch 201 detects a loop in the network 200.

In this example, the loop in network 200 is formed by links A 210, B 212, and C 220. A packet (e.g., a message) with an unknown or inconsistent destination may be trapped in this loop indefinitely. Therefore, the switches 201, 202, and 203 attempt to detect loops and avoid passing packets via the loops. Because network topologies are dynamically changing, network entities typically attempt to detect the loops by automatic techniques (e.g., a spanning tree algorithm).

A “tree” is defined as a connected simple graph with no cycles (loops), it is also known as a graph with no redundant paths. In FIG. 2, the switches 201, 202, and 203 form a network topology that has a loop. A specific link (e.g. link C 214) may be dropped or discarded in order to form a tree-like topology. Data packets are not sent across a dropped or discarded link, yet a discarded link may be kept as a backup link (in case of failure of other links). For example, if link C 214 is dropped or discarded, then the path between computer 204 and computer 205 is via link D 216, link A 210, and link E 218.

Having a link come up (i.e., be available) and go down (i.e., be unavailable) may cause side effects to network entities (e.g., switches) that try consistently to determine whether the network topology changed. The link switching from being available to being unavailable or switching from being unavailable to being available may also be referred to as a “link toggle.” Embodiments of the invention prevent this link toggle when a driver is to be unloaded and reloaded (e.g., due to reconfiguring of the network adapter 112). By preventing the link from becoming unavailable, embodiments of the invention avoid exposing any difference to external network entities that are attempting to detect any change in the network 200. For example, if a driver at computer 205 is to be unloaded and reloaded, embodiments of the invention do not drop link E 218 between computer 205 and switch 202 for a certain period of time, to allow the driver to be reloaded, without connectivity problems.

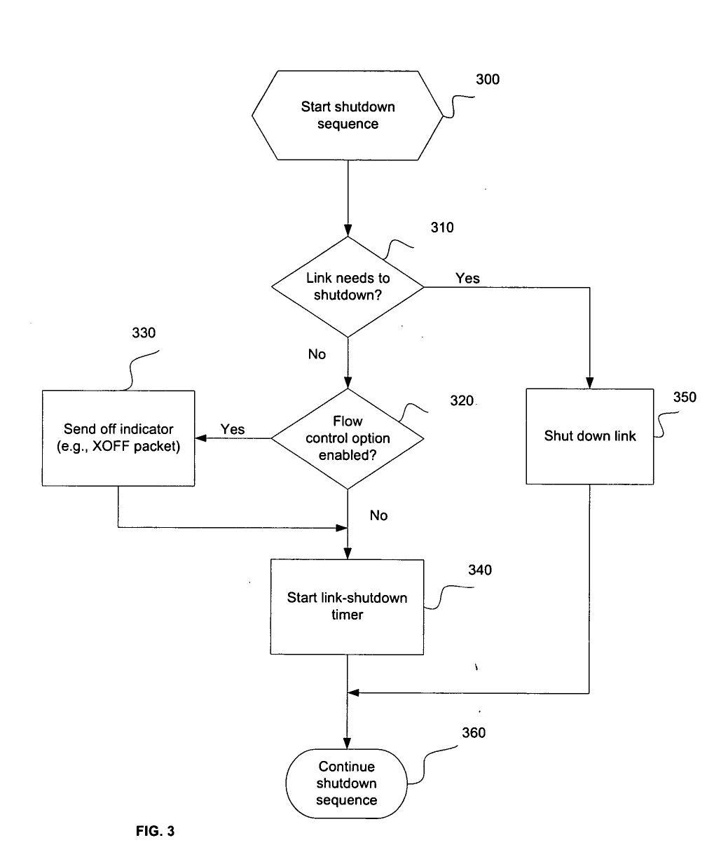

FIG. 3 illustrates operations for a shutdown sequence in a driver (e.g., a device driver 120) in accordance with certain embodiments of the invention. Control begins at block 300 with the driver starting the shutdown sequence. In block 310, the driver determines whether the link needs to be shut down. In certain embodiments, the operating system 110, for example, is able to indicate to the driver whether the link should be kept up (e.g., a wakeup pattern is configured). If so, processing continues to block 350, otherwise, processing continues to block 320. In block 350, the driver shuts down the link and continues to block 360. In block 320, the driver determines whether a flow control option is enabled. A flow control option may be enabled to indicate that an off indicator (e.g., an XOFF packet) is to be sent to other network entities to indicate that data packets (e.g., messages) are not to be sent from those other network entities until an on indicator (e.g., an XON packet) is sent to indicate that the other network entities may start sending messages again. If the flow control option is enabled, then processing continues to block 330, otherwise, processing continues to block 340. In block 330, the driver sends an off indicator (e.g., an XOFF packet) to prevent packets from other network entities from being placed in, for example, hardware queues.

In block 340, the driver starts a link-shutdown timer. The link-shutdown timer counts the maximum amount of time that the link is to be kept up while the network driver is being unloaded. If the driver is re-loaded within the link-shutdown interval counted by the link-shutdown timer, then the link is kept up. If the driver is not loaded within the link-shutdown interval counted by the link-shutdown timer, then the link is brought down. In certain embodiments, the link-shutdown interval that is counted by the link-shutdown timer may be set by, for example, a system administrator. In block 360, the shutdown sequence continues.

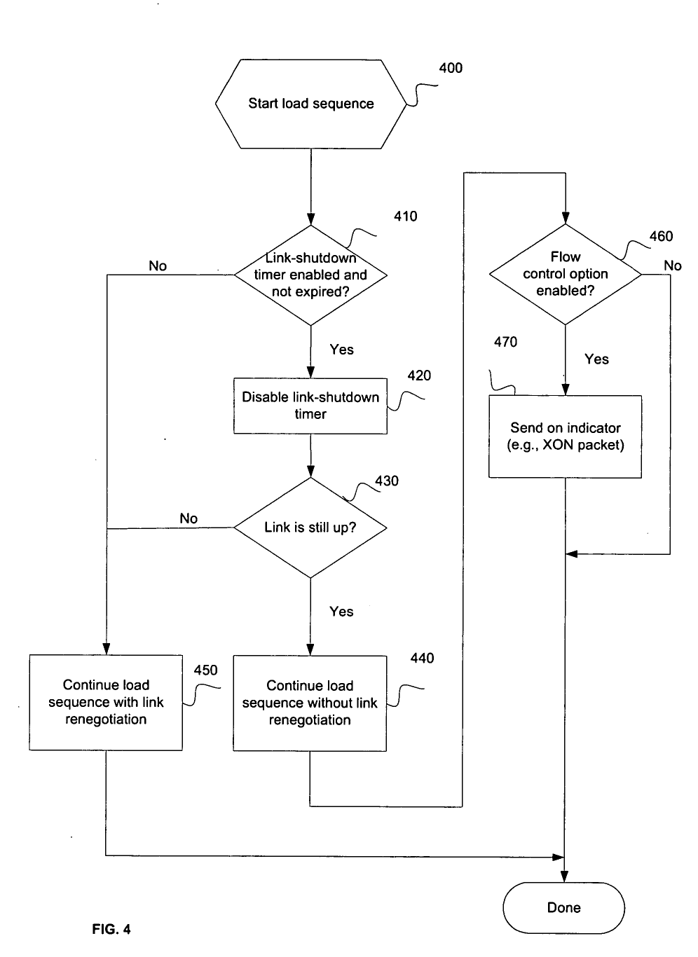

FIG. 4 illustrates operations for a load sequence in a driver (e.g., a device driver 120) in accordance with certain embodiments of the invention. Control begins at block 400 with start of the load sequence. In block 410, the driver determines whether the link-shutdown timer is enabled and has not expired. If so, processing continues to block 420, otherwise, processing continues to block 450. In block 420, the driver disables (i.e., deactivates) the link-shutdown timer. In bock 430, the driver determines whether the link is still up. If the link is still up, processing continues to block 440, otherwise, processing continues to block 450. In block 440, the driver continues the load sequence without link renegotiation. In block 450, the driver continues the load sequence with link renegotiation. In block 460, the driver determines whether the flow control option is enabled. If the flow control option is set to on, processing continues to block 470, otherwise, processing is done. In block 470, the driver sends an on indicator (e.g., an XON packet), and then processing is done.

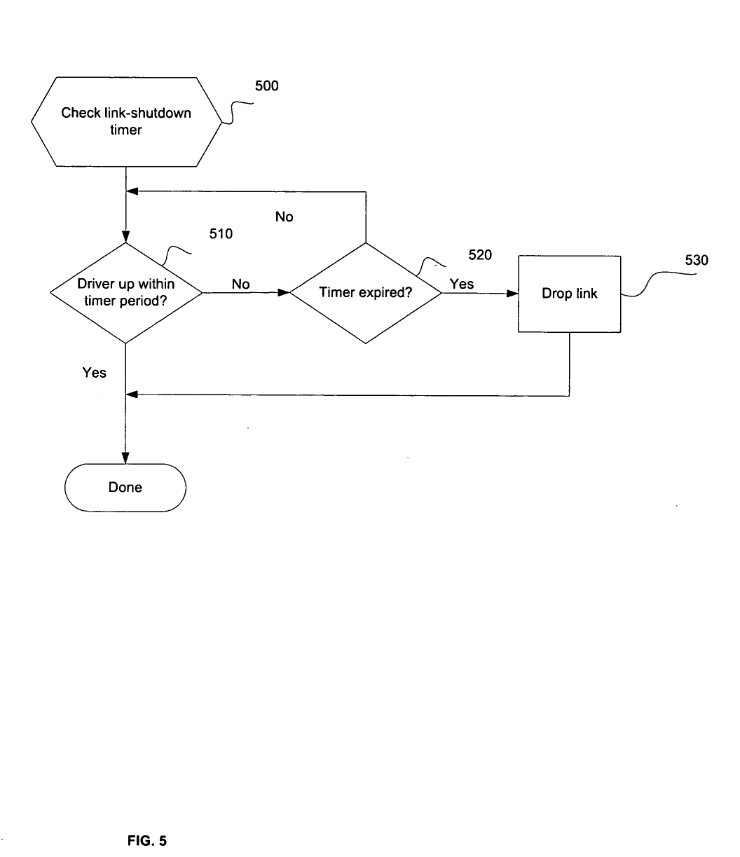

FIG. 5 illustrates operations for processing the link-shutdown timer in a physical communications layer 132 of a network adapter 130 in accordance with certain embodiments of the invention. Control begins at block 500 with the physical communications layer 132 of the network adapter 130 checking the link-shutdown timer. In block 510, the physical communications layer 132 determines whether the driver is loaded within the link-shutdown interval counted by the link-shutdown timer. In certain embodiments, the driver may write a value into a particular register to indicate that loading is complete, and the physical communications layer 132 reads this register to determine whether the driver is loaded. If so, processing is done, otherwise, processing continues to block 520. That is, if the driver is loaded before the link-shutdown timer expires, then the link is kept up and does not need to be renegotiated. In block 520, the physical communications layer 132 determines whether the timer has expired. If so, processing continues to block 530, otherwise, processing continues to block 510. In block 530, since the driver did not load before the timer expired, the physical communications layer 132 drops the link.

Thus, the driver triggers a link-shutdown timer for dropping the link between, for example, a computer and a switch. The driver may also send an XOFF packet if flow control is enabled. Then, the network hardware is uninitialized and the driver is unloaded. The physical communications layer 132 drops the link if the driver is not loaded within a link-shutdown interval. Also, when the driver is loaded again, the driver sends an XON packet, if flow control is enabled and disables the link-shutdown timer.

### Additional Embodiment Details

The described techniques for maintaining a link between two network entities may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of embodiments of the present invention, and that the article of manufacture may comprise any information bearing medium known in the art.

In the described embodiments, certain logic was implemented in a driver or a network adapter. In additional embodiments, the driver and/or network adapter may include a processor and memory to execute instructions loaded into memory to perform link management, as opposed to implementing the link management logic in hardware, such as an Application Specific Integrated Circuit (ASIC). In alternative embodiments, the logic implemented in the driver and/or network adapter may be implemented all or in part in network hardware.

In certain embodiments, the network adapter may be implemented in a network adapter card inserted in a slot of the computer 102, such as a PCI card. In alternative embodiments, the network adapter may comprise integrated circuit components mounted on the computer 102 motherboard.

In certain embodiments, a device driver and network adapter may be included in a computer system including a storage controller, such as a SCSI, Integrated Drive Electronics (IDE), Redundant Array of Independent Disk (RAID), etc., that manages access to a non-volatile storage device, such as a magnetic disk drive, tape media, optical disk, etc. In alternative embodiments, the network adapter may be included in a system that does not include a storage controller, such as certain hubs and switches.

In certain embodiments, the network adapter may be configured to transmit data across a cable connected to a port on the network adapter. In alternative embodiments, the network adapter embodiments may be configured to transmit data over a wireless network or connection, such as wireless LAN, Bluetooth, etc.

The illustrated logic of FIGS. 3, 4, and 5 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

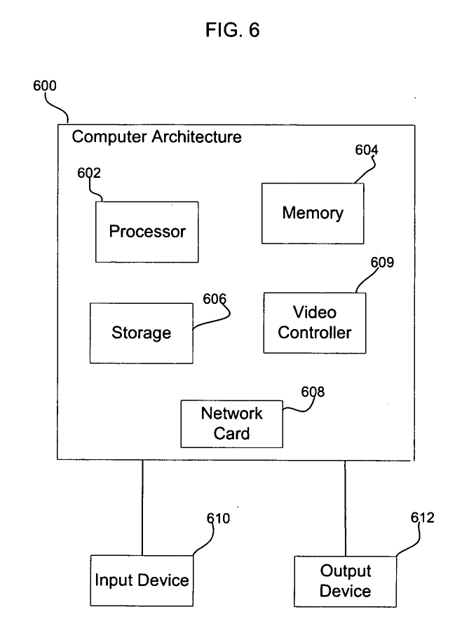

FIG. 6 illustrates one embodiment of a computer architecture 600 of the network components, such as the computers shown in FIG. 1 and FIG. 2. The architecture 600 may include a processor 602 (e.g., a microprocessor), a memory 604 (e.g., a volatile memory device), and storage 606 (e.g., a non-volatile storage, such as magnetic disk drives, optical disk drives, a tape drive, etc.). The storage 606 may comprise an internal storage device or an attached or network accessible storage. Programs in the storage 606 are loaded into the memory 604 and executed by the processor 602 in a manner known in the art. The architecture further includes a network card 608 to enable communication with a network, such as an Ethernet, a Fibre Channel Arbitrated Loop, etc. Further, the architecture may, in certain embodiments, include a video controller 609 to render information on a display monitor, where the video controller 609 may be implemented on a video card or integrated on integrated circuit components mounted on the motherboard. As discussed, certain of the network devices may have multiple network cards. An input device 610 is used to provide user input to the processor 602, and may include a keyboard, mouse, pen-stylus, microphone, touch sensitive display screen, or any other activation or input mechanism known in the art. An output device 612 is capable of rendering information transmitted from the processor 602, or other component, such as a display monitor, printer, storage, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method for maintaining a link between a first network entity and a second network entity, wherein the first network entity includes a network adapter and a driver, comprising:
determining, with the network adapter, whether the driver was loaded before a link-shutdown timer expired, wherein the link-shutdown timer is associated with the link;
continuing processing without dropping the link, with the network adapter, in response to the driver being loaded before the link-shutdown timer expired; and
dropping the link, with the network adapter, in response to the driver not being loaded before the link-shutdown timer expired.

2. The method of claim 1, further performing:
determining, with the network adapter, whether a register has a value indicating that the driver has been loaded.

3. The method of claim 1, further performing:
determining, with the network adapter, whether the link-shutdown timer has expired; and
periodically determining, with the network adapter, whether the driver was loaded in response to determining that the link-shutdown timer has not expired.

4. The method of claim 1, further performing:
determining, with the network adapter, whether the link-shutdown timer has expired; and
periodically determining, with the network adapter, whether the driver was loaded in response to the driver not being loaded and the link-shutdown timer not having expired.

5. A method implemented in a driver executing in a first network entity for maintaining a link between the first network entity and a second network entity, wherein the driver performs:
starting a link-shutdown timer for dropping a link;
upon being reloaded, determining whether the link is available; and
continuing processing without renegotiating the link in response to the link being available.

6. The method of claim 5, wherein the driver further performs:
renegotiating the link in response to the link being available.

7. The method of claim 5, wherein the driver further performs:
determining, whether flow control is enabled; and
sending an indicator to the second network entity to indicate that the second network entity is to stop sending data packets to the first network entity in response to flow control being enabled.

8. The method of claim 7, wherein after the driver is reloaded, the driver further performs:
determining whether flow control is enabled; and
sending an indicator to the second network entity to indicate that the second network entity is to start sending data packets to the first network entity in response to flow control being enabled.

9. The method of claim 5, further performing:
when the driver is reloaded, disabling the link-shutdown timer in response to the link-shutdown timer being enabled and not being expired.

10. A system coupled to a network and data storage, comprising:
a storage controller managing Input/Output (I/O) access to the data storage;
at least one driver;
a network adapter; and
control logic to cause the network adapter to perform operations, the operations comprising:
(i) determining, with the network adapter, whether the driver was loaded before a link-shutdown timer expired;
(i) continuing processing without dropping a link for which the link-shutdown timer was started in response to the driver being loaded before the link-shutdown timer expired; and
(iii) dropping the link in response to the driver not being loaded before the link-shutdown timer expired.

11. The network adapter of claim 10, wherein the operations caused by the control logic further comprise:
determining whether a register has a value indicating that the driver has been loaded.

12. The network adapter of claim 10, wherein the operations caused by the control logic further comprise:
determining whether the link-shutdown timer has expired; and
periodically determining whether the driver was loaded before the link-shutdown timer expired in response to determining that the link-shutdown timer has not expired.

13. The network adapter of claim 10, wherein the operations caused by the control logic further comprise:
determining whether the link-shutdown timer has expired; and
periodically determining whether the driver was loaded in response to the driver not being loaded and the link-shutdown timer not having expired.

14. A system coupled to a network and data storage, comprising:
a processor;
a storage controller managing Input/Output (I/O) access to the data storage; and
a driver, executed by the processor, to perform operations, the operations comprising:
(i) starting a link-shutdown timer for dropping a link;
(iii) upon being reloaded, determining whether the link is available; and
(iii) continuing processing without renegotiating the link in response to the link being available.

15. The system of claim 14, wherein the operations further comprise:
renegotiating the link in response to the link not being available.

16. The system of claim 14, wherein the operations further comprise:
determining whether flow control is enabled; and
sending an indicator to the second network entity to indicate that the second network entity is to stop sending data packets to the first network entity in response to flow control being enabled.

17. The system of claim 16, wherein after the driver is loaded, the operations further comprise:
determining whether flow control is enabled; and
sending an indicator to the second network entity to indicate that the second network entity is to start sending data packets to the first network entity in response to flow control being enabled.

18. The system of claim 14, wherein the operations further comprise:
when the driver is reloaded, disabling the link-shutdown timer in response to the link-shutdown timer being enabled and not being expired.

19. An article of manufacture for maintaining a link between a first computer and a network entity, wherein the first computer includes a network adapter and a driver, and wherein the article of manufacture causes operations to be performed in the network adapter, the operations comprising:
(i) determining, with the network adapter, whether the driver was loaded before a link-shutdown timer expired, wherein the link-shutdown timer is associated with the link;
(i) continuing processing without dropping the link in response to the driver being loaded before the link-shutdown timer expired; and
(iii) dropping the link in response to the driver not being loaded before the link-shutdown timer expired.

20. The article of manufacture of claim 19, wherein the operations further comprise:
determining whether a register has a value indicating that the driver has been loaded.

21. The article of manufacture of claim 19, wherein the operations further comprise:
determining whether the link-shutdown timer has expired; and
periodically determining whether the driver was loaded before the link-shutdown timer expired in response to determining that the link-shutdown timer has not expired.

22. The article of manufacture of claim 19, wherein the operations further comprise:
determining whether the link-shutdown timer has expired; and
periodically determining whether the driver was loaded in response to the driver not being loaded and the link-shutdown timer not having expired.

23. An article of manufacture for maintaining a link between a first computer and a network entity, wherein the first computer includes a driver, and wherein the article of manufacture causes operations to be performed in the driver, the operations comprising:
starting a link-shutdown timer for dropping a link;
upon being reloaded, determining whether the link is available; and
continuing processing without renegotiating the link in response to the link being available.

24. The article of manufacture of claim 23, wherein the operations further comprise:
renegotiation the link in response to the link not being available.

25. The article of manufacture of claim 23, wherein the operations further comprise:
determining, whether flow control is enabled; and
sending an indicator to the second network entity to indicate that the second network entity is to stop sending data packets to the first network entity in response to flow control being enabled.

26. The article of manufacture of claim 25, wherein after the driver is loaded, the operations further comprise:
determining whether flow control is enabled; and
sending an indicator to the second network entity to indicate that the second network entity is to start sending data packets to the first network entity in response to flow control being enabled.

27. The article of manufacture of claim 23, wherein the operations further comprise:
when the driver is reloaded, disabling the link-shutdown timer in response to the link-shutdown timer being enabled and not having expired.
